(19) United States
(12) Patent Application Publication
(10) Pub. No.: US 2025/0073513 A1
(43) Pub. Date: Mar. 6, 2025

(54) CABINET WITH FIRE EXTINGUISHER

(71) Applicant: VERTIV CORPORATION, Westerville, OH (US)

(72) Inventors: Aditya Cvn, Hyderabad (IN); SRINIVASAN NATARAJAN, Erode (DT) (IN); UTKARSH DILIPRAO CHARAPALE, Dist: Kolhapur (IN); JIN ELKINS, Auburn, AL (US)

(73) Assignee: VERTIV CORPORATION, Westerville, OH (US)

(21) Appl. No.: 18/823,680

(22) Filed: Sep. 4, 2024

(30) Foreign Application Priority Data
Sep. 4, 2023 (IN) 202321059237

(51) Int. Cl. A62C 3/16; A62C 37/36

(52) U.S. Cl. CPC A62C 3/16; A62C 37/04; A62C 37/36

(57) ABSTRACT

An electronic equipment cabinet can include one or more mounting rails for supporting electronic equipment, such as computing equipment, within the cabinet, at least one fire sensor, and at least one fire extinguisher. The fire sensor(s) can be configured to detect fire within the cabinet and/or outside the cabinet. For example, the fire sensor(s) can include an internal fire sensor configured to detect fire within the cabinet and/or an external fire sensor configured to detect fire outside the cabinet. The fire extinguisher can be configured to extinguish fire within the cabinet and/or outside the cabinet. For example, the fire extinguisher(s) can include an internal fire extinguisher configured to extinguish fire within the cabinet and/or an external fire extinguisher configured to extinguish fire outside the cabinet.

### CROSS-REFERENCE TO RELATED APPLICATIONS

This application claims the benefit of Indian provisional patent application No. 20/232,1059237 filed Sep. 4, 2023, the entire contents of which are incorporated herein by reference.

### TECHNICAL FIELD

The present disclosure relates generally to electronic equipment cabinets and more specifically relates to electronic equipment cabinets, such as computer equipment cabinets, having fire extinguishing capabilities.

### BACKGROUND

Whenever there is a fire in or near an electronics cabinet, an internal temperature of the cabinet may rise. Rising temperatures within an electronics cabinet can cause electronics, such as computer servers, to shut down, increasing downtime. There is a need to prevent or reduce internal temperature increases, such as from fire or solar induced heat, within electronic equipment cabinets.

### SUMMARY

Applicant has created new and useful devices, systems and methods for electronic equipment cabinets. In at least one embodiment, an electronic equipment cabinet according to the disclosure can include one or more mounting rails for supporting electronic equipment, such as computing equipment, within the cabinet, at least one fire sensor for sensing a fire in or about the cabinet, and at least one fire extinguisher for supporting extinguishment of a fire in or about the cabinet. The fire sensor(s) can be adapted for detecting fire within the cabinet and/or outside the cabinet, which can include comprising internal and/or external fire sensor(s). The fire extinguisher(s) can be adapted for extinguishing or helping extinguish a fire within the cabinet and/or outside the cabinet, which can include comprising internal and/or external fire extinguisher(s).

In at least one embodiment, an electronic equipment cabinet can include one or more mounting rails for supporting electronic equipment, such as computing equipment, within the cabinet, at least one fire sensor, and at least one fire extinguisher. In at least one embodiment, the fire sensor(s) can be configured to detect fire within the cabinet and/or outside the cabinet. For example, in at least one embodiment, the fire sensor(s) can include an internal fire sensor configured to detect fire within the cabinet and/or an external fire sensor configured to detect fire outside the cabinet.

In at least one embodiment, the at least one fire sensor can include a plurality of temperature sensors located within the cabinet. In at least one embodiment, the temperature sensors can detect a fire within the cabinet and/or a location of the fire within the cabinet. In at least one embodiment, the at least one fire extinguisher can direct fire extinguishing material toward the location of the fire within the cabinet. For example, in at least one embodiment, the at least one fire extinguisher can include a plurality of nozzles. In at least one embodiment, each nozzle can direct fire extinguishing material toward a different location within the cabinet. In at least one embodiment, a controller can monitor the temperature sensors and open one or more of the nozzles configured to direct fire extinguishing material toward the location of the fire within the cabinet.

In at least one embodiment, the at least one fire extinguisher can include at least one nozzle configured to direct fire extinguishing material toward different locations within the cabinet. For example, the nozzle can be articulated to direct the fire extinguishing material toward the location of the fire within the cabinet. In at least one embodiment, a controller can monitor the temperature sensors and articulate, orient, or otherwise adapt the at least one nozzle to direct fire extinguishing material toward the location of the fire within the cabinet.

In at least one embodiment, the at least one fire extinguisher can direct fire extinguishing material throughout the cabinet, essentially engulfing the cabinet's interior with the fire extinguishing material, rather than directing the fire extinguishing material to a specific location within the cabinet. In at least one embodiment, the fire extinguishing material can be a dry powder, a non-conductive liquid, fire extinguishing pods, fire extinguishing gas, another fire extinguishing material, or any combination thereof.

In at least one embodiment, the at least one fire sensor can detect a direction of a fire external to the cabinet. In at least one embodiment, the at least one fire sensor can include a temperature sensor configured to detect an air temperature of the air entering the cabinet.

In at least one embodiment, the at least one fire extinguisher can include at least one nozzle configured to direct fire extinguishing material away from the cabinet. In at least one embodiment, the at least one fire extinguisher can include at least one nozzle configured to direct fire extinguishing material encircling the cabinet.

In at least one embodiment, the at least one fire extinguisher can include a plurality of nozzles. In at least one embodiment, each nozzle can direct fire extinguishing material in a different direction. In at least one embodiment, a controller can monitor the at least one fire sensor and open one or more of the nozzles configured to direct fire extinguishing material in the direction of the fire external to the cabinet.

In at least one embodiment, the at least one fire extinguisher can include a dispenser configured to eject fire extinguishing pods outward from the cabinet. In at least one embodiment, the dispenser can eject the fire extinguishing pods encircling the cabinet. In at least one embodiment, the at least one fire sensor can detect a direction of a fire external to the cabinet. In at least one embodiment, the dispenser can eject the fire extinguishing pods in the direction of the fire external to the cabinet.

In at least one embodiment, a solar shield can be mounted upon the cabinet. In at least one embodiment, the solar shield can reduce the solar induced heat within the cabinet. In at least one embodiment, the solar shield can house one or more fire sensor(s) and/or one or more fire extinguisher(s).

In at least one embodiment, the at least one fire extinguisher can include an inclined surface configured to direct fire extinguishing material toward a direction of a fire external to the cabinet. In at least one embodiment, the at least one fire extinguisher can include a stopper configured to release the fire extinguishing material upon detection of the fire external to the cabinet. In at least one embodiment, the at least one fire extinguisher can include a plunger configured to direct fire extinguishing material toward a direction of a fire external to the cabinet.

In at least one embodiment, the at least one fire extinguisher can include a tank configured to store fire extinguishing material and/or a conduit surrounding the cabinet. In at least one embodiment, the conduit can direct the fire extinguishing material toward a direction of a fire external to the cabinet upon detection of the fire external to the cabinet.

In at least one embodiment, the cabinet can include a cover configured to cover at least a portion of the at least one fire extinguisher. In at least one embodiment, the cover can uncover the portion of the at least one fire extinguisher upon detection of a fire external to the cabinet.

### BRIEF DESCRIPTION OF THE DRAWINGS

FIG. 1 is a sectional elevation view of one of many embodiments of an electronic equipment cabinet according to the disclosure.

FIG. 2 is another sectional elevation view of one of many embodiments of an electronic equipment cabinet according to the disclosure.

FIG. 3 is a sectional elevation view of another one of many embodiments of an electronic equipment cabinet according to the disclosure.

FIG. 4 is a block diagram of an electronic equipment cabinet system according to the disclosure.

FIG. 5 is an elevation view of still another one of many embodiments of an electronic equipment cabinet according to the disclosure.

FIG. 6 is an elevation view of another one of many embodiments of an electronic equipment cabinet according to the disclosure.

FIG. 7 is an elevation view of another one of many embodiments of an electronic equipment cabinet according to the disclosure.

FIG. 8 is another elevation view of one of many embodiments of an electronic equipment cabinet according to the disclosure.

FIG. 9 is an elevation view of still another one of many embodiments of an electronic equipment cabinet according to the disclosure.

FIG. 10 is an elevation view of another one of many embodiments of an electronic equipment cabinet according to the disclosure.

FIG. 11 is an elevation view of still another one of many embodiments of an electronic equipment cabinet according to the disclosure.

FIG. 12 is a partial close-up view of a fire extinguishing sub-system of the electronic equipment cabinet of FIG. 11.

FIG. 13 is an elevation view of still another one of many embodiments of an electronic equipment cabinet according to the disclosure.

FIG. 14 is a partial close-up view of a fire extinguishing sub-system of the electronic equipment cabinet of FIG. 13.

FIG. 15 is a plan view of still another one of many embodiments of an electronic equipment cabinet according to the disclosure.

FIG. 16 is a plan view of still another one of many embodiments of an electronic equipment cabinet according to the disclosure.

FIG. 17 is a partial close-up view of a fire extinguishing sub-system of the electronic equipment cabinet of FIG. 16.

### DETAILED DESCRIPTION

The figures described above and the written description of specific structures and functions below are not presented to limit the scope of what Applicant has invented or the scope of the appended claims. Rather, the figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present inventions will require numerous implementation-specific decisions to achieve the developer's ultimate goal for the commercial embodiment. Such implementation-specific decisions may include, and likely are not limited to, compliance with system-related, business-related, government-related and other constraints, which may vary by specific implementation, location and from time to time. While a developer's efforts might be complex and time-consuming in an absolute sense, such efforts would be, nevertheless, a routine undertaking for those of skill in this art having benefit of this disclosure. It must be understood that the inventions disclosed and taught herein are susceptible to numerous and various modifications and alternative forms.

The use of a singular term, such as, but not limited to, “a,” is not intended as limiting of the number of items. Also, the use of relational terms, such as, but not limited to, “top,” “bottom,” “left,” “right,” “upper,” “lower,” “down,” “up,” “side,” and the like are used in the written description for clarity in specific reference to the figures and are not intended to limit the scope of the inventions or the appended claims. The terms “including” and “such as” are illustrative and not limitative. The terms “couple,” “coupled,” “coupling,” “coupler,” and like terms are used broadly herein and can include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and can further include without limitation integrally forming one functional member with another in a unity fashion. The coupling can occur in any direction, including rotationally. Further, all parts and components of the disclosure that are capable of being physically embodied inherently include imaginary and real characteristics regardless of whether such characteristics are expressly described herein, including but not limited to characteristics such as axes, ends, inner and outer surfaces, interior spaces, tops, bottoms, sides, boundaries, dimensions (e.g., height, length, width, thickness), mass, weight, volume and density, among others.

Any process flowcharts discussed herein illustrate the operation of possible implementations of systems, methods, and computer program products according to various embodiments of the present disclosure. In this regard, each block in a flowchart may represent a module, segment, or portion of code, which can include one or more executable instructions for implementing the specified logical function(s). It should also be noted that, in some implementations, the function(s) noted in the block(s) might occur out of the order depicted in the figures. For example, blocks shown in succession may, in fact, be executed substantially concurrently. It will also be noted that each block of flowchart illustration can be implemented by special purpose hardware-based systems that perform the specified functions or acts, or combinations of special purpose hardware and computer instructions.

Applicant has created new and useful devices, systems and methods for electronic equipment cabinets. In at least one embodiment, an electronic equipment cabinet according to the disclosure can include one or more mounting rails for supporting electronic equipment, such as computing equipment, within the cabinet, at least one fire sensor for sensing a fire in or about the cabinet, and at least one fire extinguisher for supporting extinguishment of a fire in or about the cabinet. The fire sensor(s) can be adapted for detecting fire within the cabinet and/or outside the cabinet, which can include comprising internal and/or external fire sensor(s). The fire extinguisher(s) can be adapted for extinguishing or helping extinguish a fire within the cabinet and/or outside the cabinet, which can include comprising internal and/or external fire extinguisher(s).

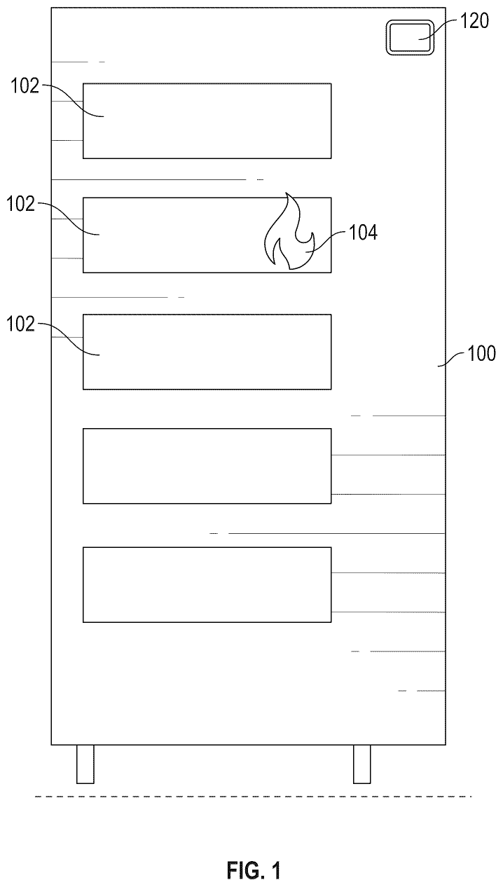

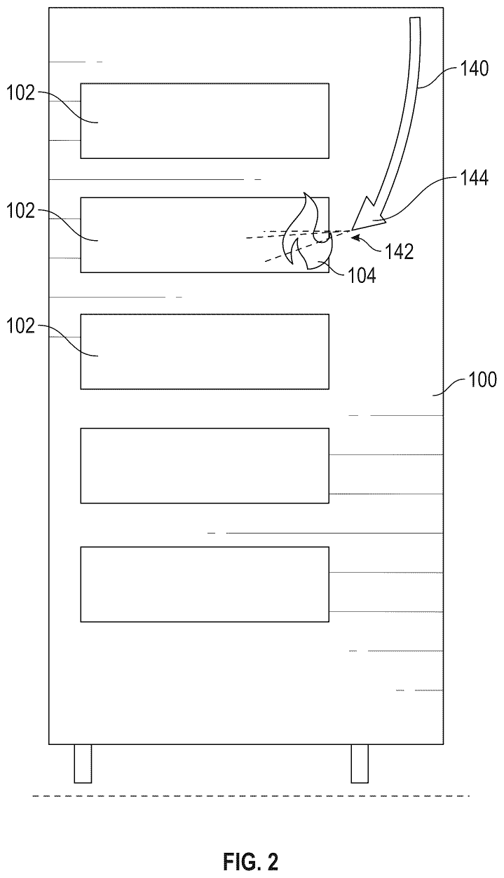

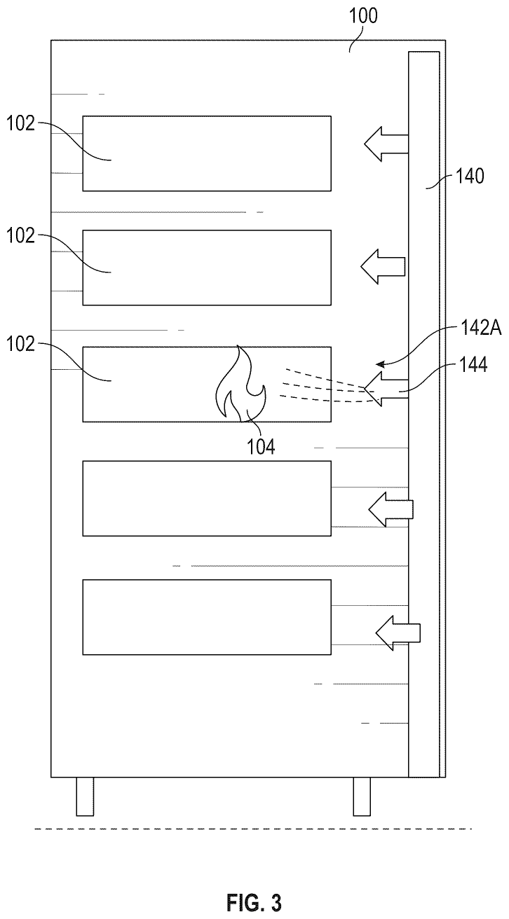

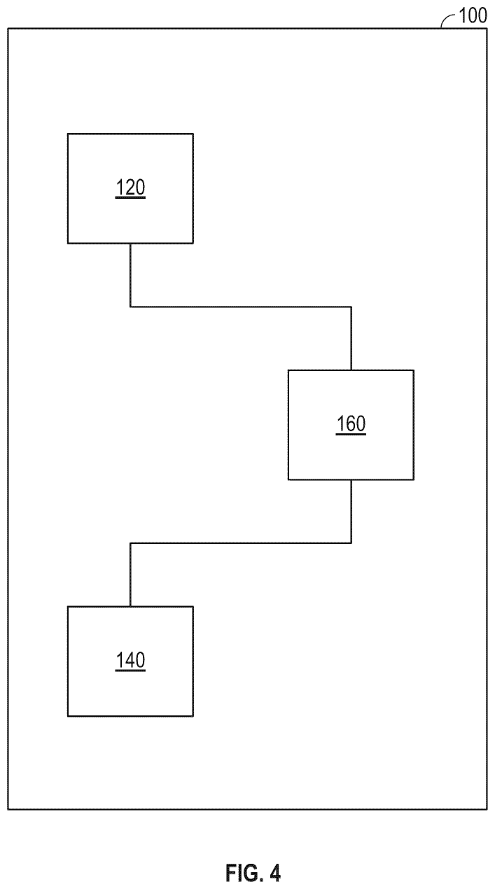

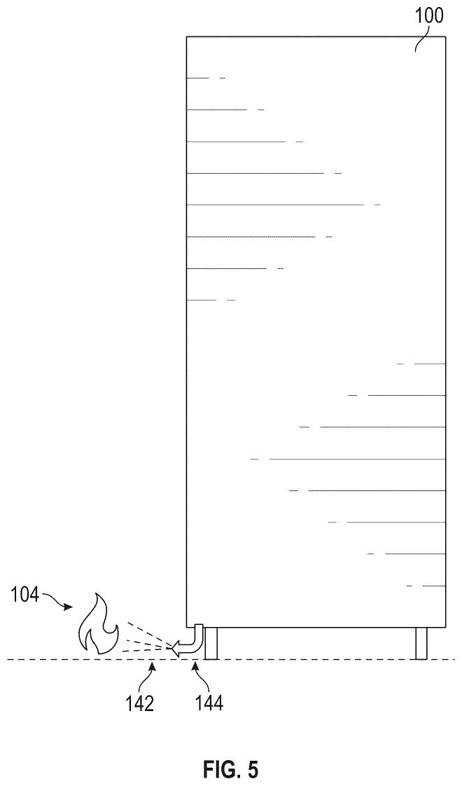

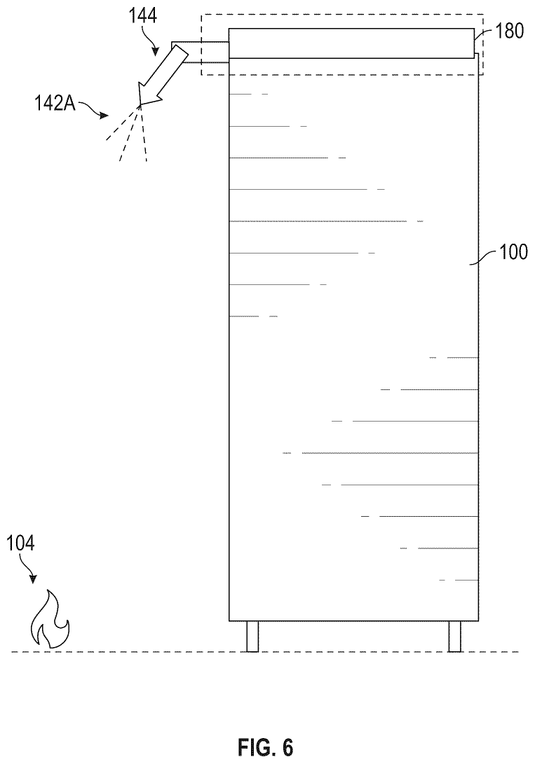

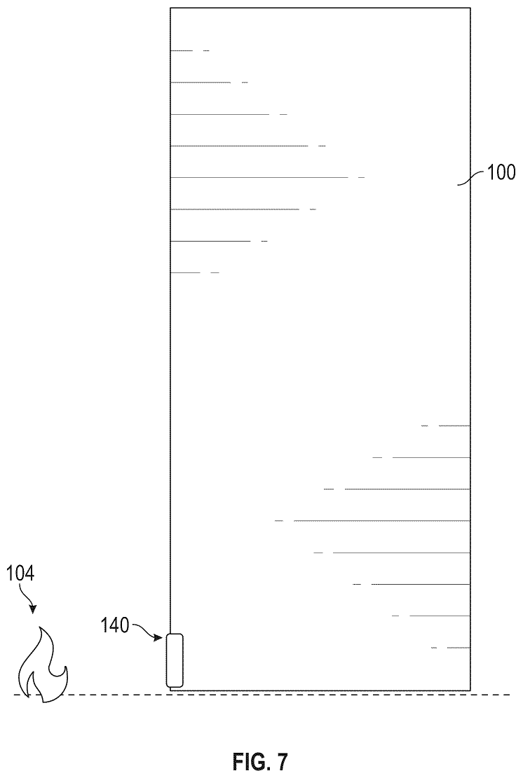

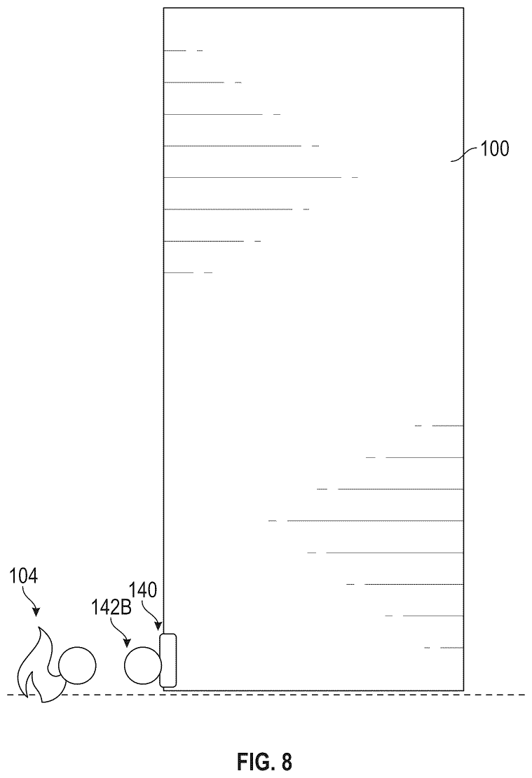

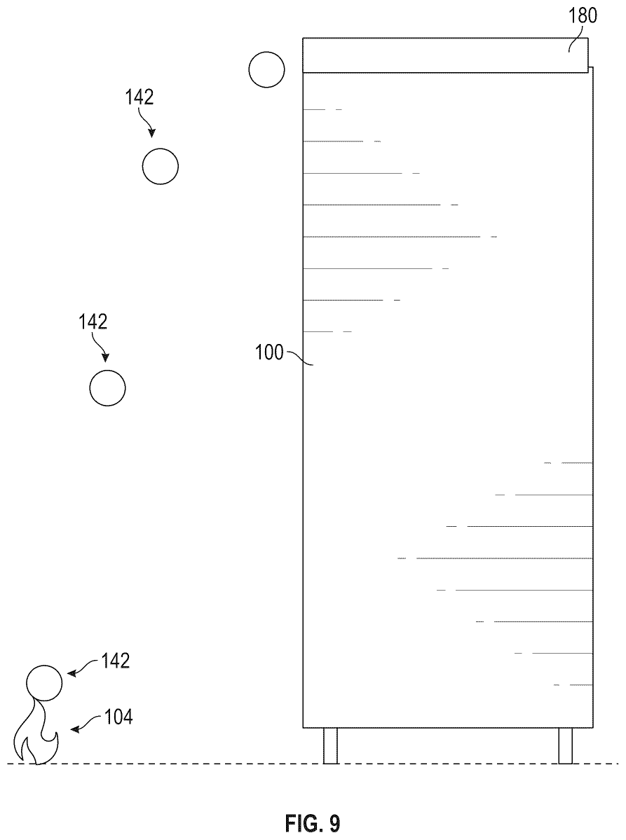

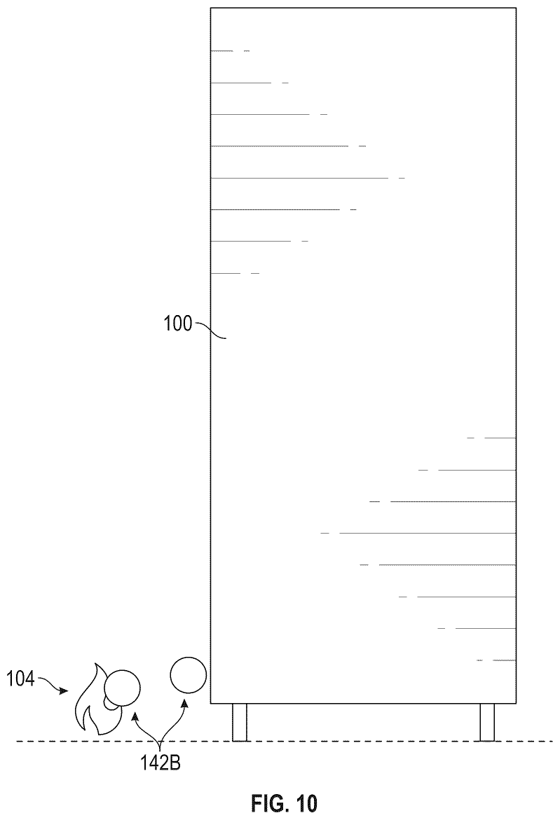

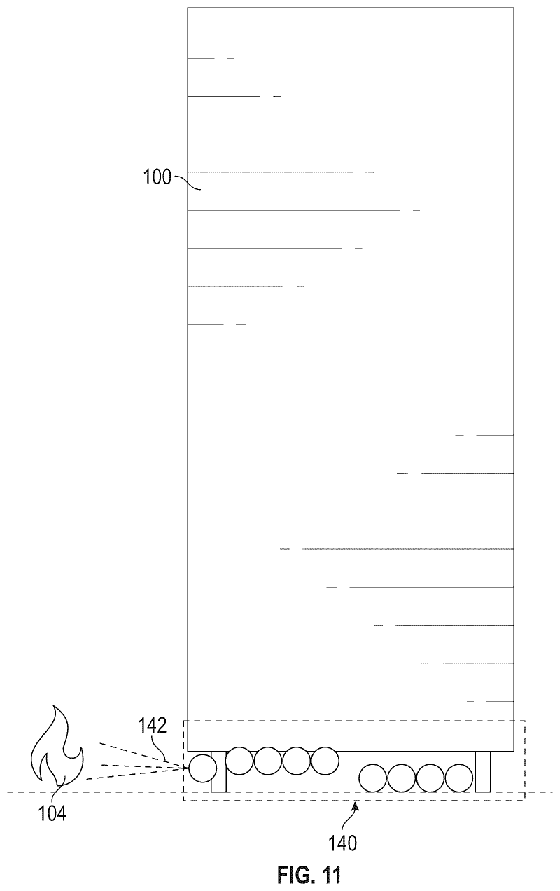

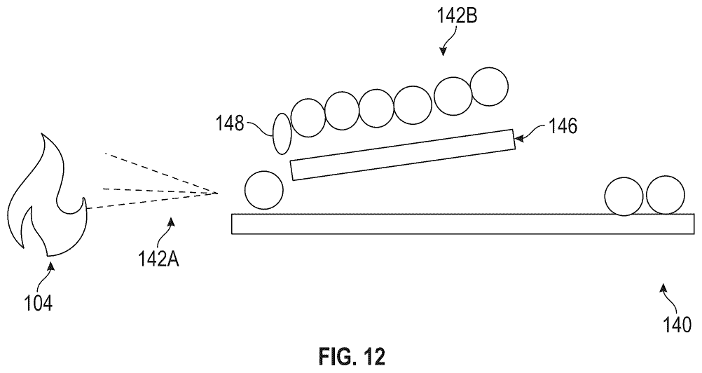

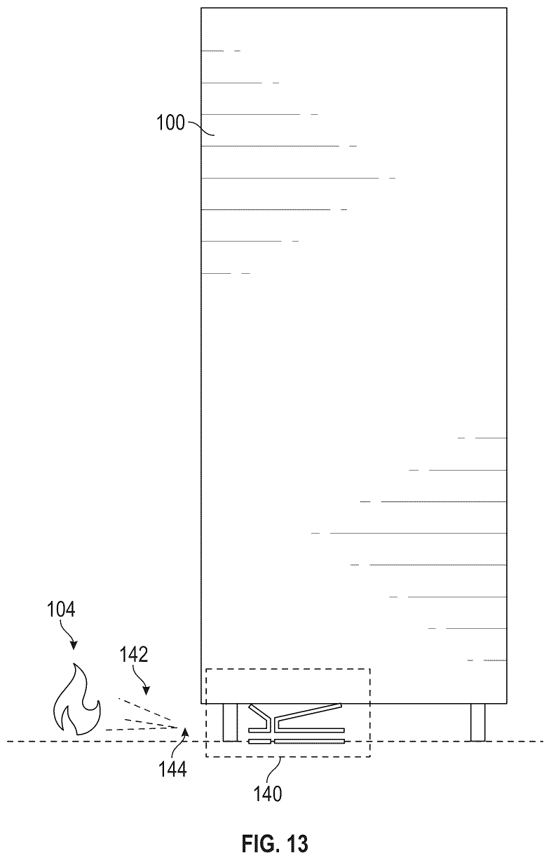

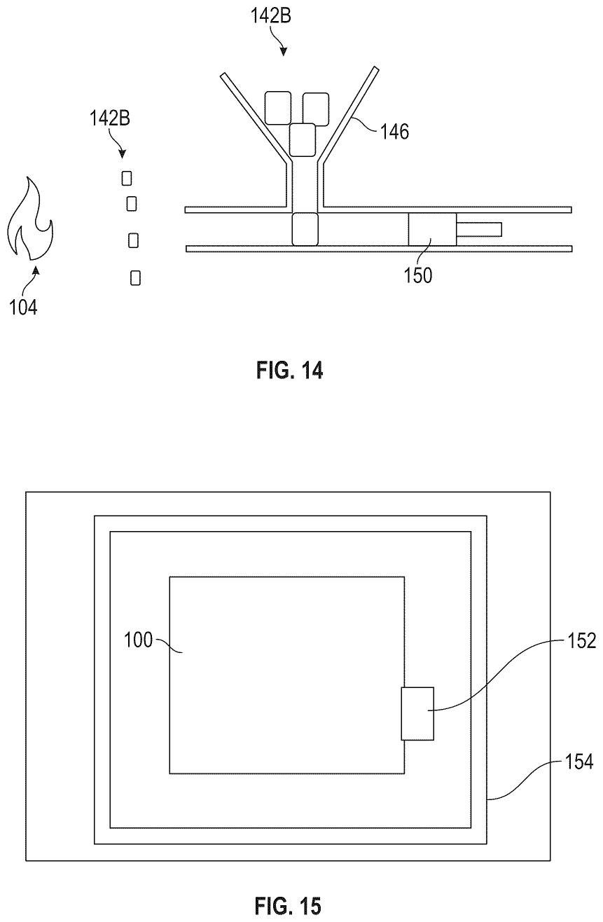

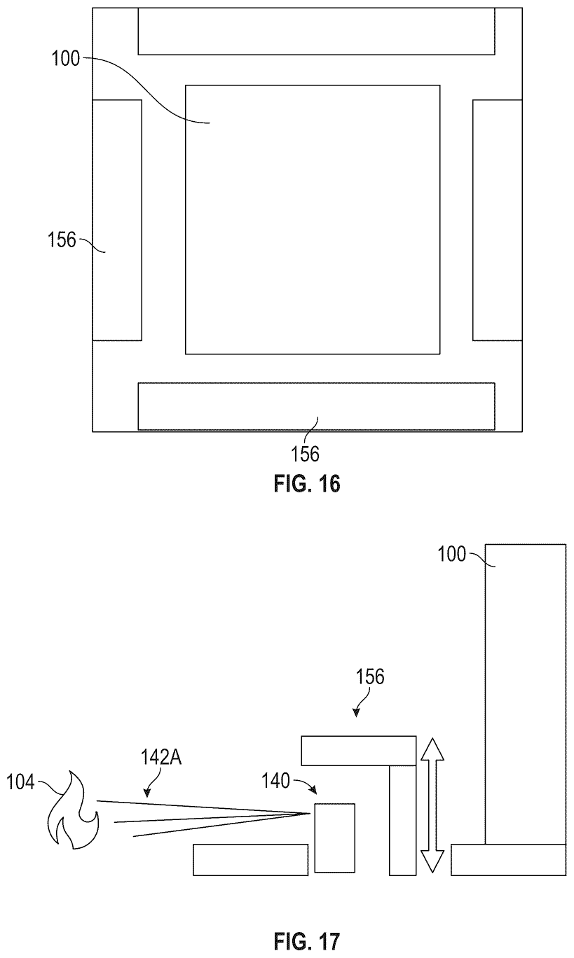

FIG. 1 is a sectional elevation view of one of many embodiments of an electronic equipment cabinet according to the disclosure. FIG. 2 is another sectional elevation view of one of many embodiments of an electronic equipment cabinet according to the disclosure. FIG. 3 is a sectional elevation view of another one of many embodiments of an electronic equipment cabinet according to the disclosure. FIG. 4 is a block diagram of an electronic equipment cabinet system according to the disclosure. FIG. 5 is an elevation view of still another one of many embodiments of an electronic equipment cabinet according to the disclosure. FIG. 6 is an elevation view of another one of many embodiments of an electronic equipment cabinet according to the disclosure. FIG. 7 is an elevation view of another one of many embodiments of an electronic equipment cabinet according to the disclosure. FIG. 8 is another elevation view of one of many embodiments of an electronic equipment cabinet according to the disclosure. FIG. 9 is an elevation view of still another one of many embodiments of an electronic equipment cabinet according to the disclosure. FIG. 10 is an elevation view of another one of many embodiments of an electronic equipment cabinet according to the disclosure. FIG. 11 is an elevation view of still another one of many embodiments of an electronic equipment cabinet according to the disclosure. FIG. 12 is a partial close-up view of a fire extinguishing sub-system of the electronic equipment cabinet of FIG. 11. FIG. 13 is an elevation view of still another one of many embodiments of an electronic equipment cabinet according to the disclosure. FIG. 14 is a partial close-up view of a fire extinguishing sub-system of the electronic equipment cabinet of FIG. 13. FIG. 15 is a plan view of still another one of many embodiments of an electronic equipment cabinet according to the disclosure. FIG. 16 is a plan view of still another one of many embodiments of an electronic equipment cabinet according to the disclosure. FIG. 17 is a partial close-up view of a fire extinguishing sub-system of the electronic equipment cabinet of FIG. 16. FIGS. 1-17 are described in conjunction with one another, at least because different features shown in different ones of FIGS. 1-17 can be combined with one another and/or omitted in one or more embodiments.

In at least one embodiment, an electronic equipment cabinet 100 can include one or more mounting rails for supporting electronic equipment 102 within the cabinet 100, at least one fire sensor 120, and at least one fire extinguisher 140. In at least one embodiment, the electronic equipment 102 can include computing equipment, such as central processing units (CPUs). Graphical processing units (GPUs), servers, data storage devices, network devices, uninterruptible power supplies (UPSs), or any combination thereof.

In at least one embodiment, the fire sensor(s) 120 can be configured to detect fire 104 within the cabinet 100 and/or outside the cabinet 100. For example, in at least one embodiment, the fire sensor(s) 120 can include an internal fire sensor configured to detect fire 104 within the cabinet 100 and/or an external fire sensor configured to detect fire 104 outside the cabinet 100. In at least one embodiment, the fire extinguisher(s) 140 can be configured to extinguish fire 104 within the cabinet 100 and/or outside the cabinet 100. For example, in at least one embodiment, the fire extinguisher(s) 140 can include an internal fire extinguisher configured to extinguish fire 104 within the cabinet 100 and/or an external fire extinguisher configured to extinguish fire 104 outside the cabinet 100.

In at least one embodiment, the at least one fire sensor 120 can include one or more temperature sensors, one or more smoke detectors, one or more infrared sensors, or any combination thereof, located within or otherwise coupled to the cabinet 100. For example, in at least one embodiment, the fire sensor(s) 120 can be or include an ionization detector, a photoelectric detector, a combination ionization/photoelectric detector, a heat detector, or any combination thereof. In at least one embodiment, the fire sensor(s) 120 can detect a fire 104 within the cabinet 100 and/or a location of the fire 104 within the cabinet 100. In at least one embodiment, the at least one fire extinguisher 140 can direct fire extinguishing material 142 toward the location of the fire 104 within the cabinet 100. For example, in at least one embodiment, the at least one fire extinguisher 140 can include a plurality of nozzles 144. In at least one embodiment, each nozzle can direct fire extinguishing material 142 toward a different location within the cabinet 100. In at least one embodiment, a controller 160 can monitor the fire sensor(s) 120 and open one or more of the nozzles 144 configured to direct fire extinguishing material 142 toward the location of the fire 104 within the cabinet 100. In at least one embodiment, the controller 160 can monitor the fire sensor(s) 120, determine the location of the fire 104 within the cabinet 100, using the fire sensor(s) 120, determine which nozzles are configured to direct fire extinguishing material 142 toward the location of the fire 104 within the cabinet 100, and open one or more of the nozzles 144 configured to direct fire extinguishing material 142 toward the location of the fire 104 within the cabinet 100. In at least one embodiment, the controller 160 can leave closed and/or confirm closure of one or more nozzles 144 configured to direct fire extinguishing material 142 toward a location(s) other than the location of the fire 104 within the cabinet 100.

In at least one embodiment, the at least one fire extinguisher 140 can include at least one nozzle configured to direct fire extinguishing material 142 toward different locations within the cabinet 100. For example, the nozzle 144 can be articulated to direct the fire extinguishing material 142 toward the location of the fire 104 within the cabinet 100. In at least one embodiment, a controller 160 can monitor the fire sensor(s) 120 and articulate, orient, or otherwise adapt the at least one nozzle 144 to direct fire extinguishing material 142 toward the location of the fire 104 within the cabinet 100. In at least one embodiment, the controller 160 can monitor the fire sensor(s) 120, determine the location of the fire 104 within the cabinet 100, using the fire sensor(s) 120, and articulate, orient, or otherwise adapt the at least one nozzle 144 to direct fire extinguishing material 142 toward the location of the fire 104 within the cabinet 100.

In at least one embodiment, the at least one fire extinguisher 140 can direct fire extinguishing material 142 throughout the cabinet 100, essentially engulfing the cabinet's 100 interior with the fire extinguishing material 142, rather than directing the fire extinguishing material 142 to a specific location within the cabinet 100. In at least one embodiment, the fire extinguishing material 142 can be or include a sprayable fire extinguishing material 142A (such as a dry powder, a non-conductive liquid, fire extinguishing gas, or any combination thereof), a pod-based fire extinguishing material 142B, or any combination thereof. In at least one embodiment, the fire extinguishing material 142 can be or include a fire retardant material, in whole or in part.

In at least one embodiment, the at least one fire sensor 120 can detect a direction of a fire 104 external to the cabinet 100. In at least one embodiment, the at least one fire sensor 120 can include one or more temperature sensors, one or more smoke detectors, one or more infrared sensors, or any combination thereof, configured to detect an air temperature of the air entering the cabinet 100, and can be located inside and/or outside the cabinet 100.

In at least one embodiment, the at least one fire sensor 120 can include one or more temperature sensors, one or more smoke detectors, one or more infrared sensors, or any combination thereof, whether mounted within the cabinet 100 or external thereto, in whole or in part. For example, a smoke detector can be an ionizing-type smoke detector, which can include an amount of radioactive material between two electrically charged plates that ionizes the air and causes current to flow between the plates. When smoke enters between the plates, it can disrupt the flow of ions, thus reducing the flow of current and activating the smoke detector. Such a smoke detector, or another type of smoke detector, can be used in conjunction with one or more temperature sensors, one or more infrared sensors, or any combination thereof, such as to reduce the chances of a false positive reading regarding the presence of a fire.

In at least one embodiment, the at least one fire extinguisher 140 can include at least one nozzle configured to direct fire extinguishing material 142 away from the cabinet 100. In at least one embodiment, the at least one fire extinguisher 140 can include at least one nozzle configured to direct fire extinguishing material 142 encircling the cabinet 100. In at least one embodiment, the at least one fire extinguisher 140 can include one or more nozzle(s) configured to direct fire extinguishing material 142 all around the cabinet 100, thereby extinguishing any fire near the cabinet 100 regardless of the direction of the fire 104.

In at least one embodiment, the at least one fire extinguisher 140 can include a plurality of nozzles. In at least one embodiment, each nozzle 144 can direct fire extinguishing material 142 in a different direction from the cabinet 100. In at least one embodiment, a controller 160 can monitor the at least one fire sensor 120 and open one or more of the nozzles 144 configured to direct fire extinguishing material 142 in the direction of the fire 104 external to the cabinet 100. In at least one embodiment, the controller 160 can monitor the fire sensor(s) 120, determine the location of the fire 104 external to the cabinet 100, using the fire sensor(s) 120, determine which nozzles 144 are configured to direct fire extinguishing material 142 toward the direction of the fire 104 external to the cabinet 100, and open one or more of the nozzles 144 configured to direct fire extinguishing material 142 toward the direction of the fire 104 external to the cabinet 100. In at least one embodiment, the controller 160 can leave closed those nozzles 144 not configured to direct fire extinguishing material 142 toward the direction of the fire 104 external to the cabinet 100.

In at least one embodiment, the at least one fire extinguisher 140 can include a dispenser configured to eject fire extinguishing material 142, such as fire extinguishing pods 142B, outward from the cabinet 100. In at least one embodiment, the dispenser 140 can eject the fire extinguishing pods 142B all around, or otherwise encircling, the cabinet 142. In at least one embodiment, the at least one fire sensor can detect a direction of a fire external to the cabinet. In at least one embodiment, the dispenser 140 can eject the fire extinguishing pods 142B all around the cabinet 100, thereby extinguishing any fire near the cabinet 100 regardless of the direction of the fire 104. In at least one embodiment, the dispenser 140 can eject the fire extinguishing pods 142B in the direction of the fire 104 external to the cabinet 100.

In at least one embodiment, a solar shield 180 can be mounted upon the cabinet 100. In at least one embodiment, the solar shield 180 can reduce the solar induced heat within the cabinet 100. In at least one embodiment, the solar shield 180 can house one or more fire sensor(s) 120, one or more fire extinguisher(s) 140, one or more controllers 160, or any combination thereof.

In at least one embodiment, the at least one fire extinguisher, or dispenser, 140 can include an inclined surface 146, such as an inclined tray or funnel, configured to direct fire extinguishing material 142 toward a direction of a fire 104 external to the cabinet 100. For example, fire extinguishing pods 142B can be or include balls of fire extinguishing material(s) and can be loaded into or onto the funnel or tray 146. In at least one embodiment, the at least one fire extinguisher 140 can include one or more stoppers, or gates, 148 configured to release the fire extinguishing material upon detection of the fire external to the cabinet. For example, one or more of the stoppers, or gates, 148 can be opened by the controller 160 upon the fire sensor(s) 120 detecting a fire 104. In at least one embodiment, the controller 160 can monitor the fire sensor(s) 120, determine the location of the fire 104 external to the cabinet 100, using the fire sensor(s) 120, determine which stoppers, or gates, 148 are configured to direct fire extinguishing material 142 toward the direction of the fire 104 external to the cabinet 100, open one or more of the stoppers, or gates, 148 configured to direct fire extinguishing material 142 toward the direction of the fire 104 external to the cabinet 100, or any combination thereof. In at least one embodiment, the at least one fire extinguisher 140 can include a plunger 150 configured to direct fire extinguishing material 142 toward a direction of a fire 104 external to the cabinet 100. For example, the plunger 150 can force sprayable fire extinguishing material 142A through a nozzle 144, thereby spraying the fire extinguishing material 142A toward the fire 104.

In at least one embodiment, the at least one fire extinguisher 140 can include a tank 152 configured to store fire extinguishing material 142 and/or a conduit 154 surrounding the cabinet 100. For example, the tank 152 can store the fire extinguishing material 142A in liquid or gaseous form. In at least one embodiment, the tank 152 can store the fire extinguishing material 142A in a pressurized state or rely on gravity feed of the fire extinguishing material 142A. In at least one embodiment, the conduit 154 can direct the fire extinguishing material 142A toward a direction of a fire 104 external to the cabinet 100 upon detection of the fire 104 external to the cabinet 100. For example, the conduit 154 can include one or more nozzles 144 and the controller 160 can monitor the fire sensor(s) 120, determine the location of the fire 104 external to the cabinet 100, using the fire sensor(s) 120, determine which nozzles 144 are configured to direct fire extinguishing material 142A toward the direction of the fire 104 external to the cabinet 100, open one or more of the nozzles 144 configured to direct fire extinguishing material 142A toward the direction of the fire 104 external to the cabinet 100, or any combination thereof. In at least one embodiment, the conduit 154 can be temperature sensitive, such that the fire 104 external to the cabinet 100 can melt a portion of the conduit 154 thereby releasing the fire extinguishing material 142A toward the direction of the fire 104 external to the cabinet 100. In at least one embodiment, the conduit 154 can include temperature sensitive nozzles 144, such that the fire 104 external to the cabinet 100 can melt a portion of the nozzles 144 thereby releasing the fire extinguishing material 142A toward the direction of the fire 104 external to the cabinet 100.

In at least one embodiment, the cabinet 100 can include one or more covers 156 configured to cover at least a portion of the at least one fire extinguisher 140. In at least one embodiment, the cover 156 can uncover the portion of the at least one fire extinguisher 140 upon detection of a fire 104 external to the cabinet 100. In at least one embodiment, the controller 160 can monitor the fire sensor(s) 120, determine the location of the fire 104 external to the cabinet 100, using the fire sensor(s) 120, determine which cover(s) 156 cover nozzle(s) 144 configured to direct fire extinguishing material 142 toward the direction of the fire 104 external to the cabinet 100, raise or otherwise open the appropriate cover(s) 156, thereby triggering one or more of the nozzles 144 configured to direct fire extinguishing material 142 toward the direction of the fire 104 external to the cabinet 100, or any combination thereof.

In at least one embodiment, an electronic equipment cabinet can include one or more mounting rails for supporting electronic equipment, such as computing equipment, within the cabinet, at least one fire sensor, and at least one fire extinguisher. In at least one embodiment, the fire sensor(s) can be configured to detect fire within the cabinet and/or outside the cabinet. For example, in at least one embodiment, the fire sensor(s) can include an internal fire sensor configured to detect fire within the cabinet and/or an external fire sensor configured to detect fire outside the cabinet.

In at least one embodiment, the at least one fire sensor can include a plurality of temperature sensors located within the cabinet. In at least one embodiment, the temperature sensors can detect a fire within the cabinet and/or a location of the fire within the cabinet. In at least one embodiment, the at least one fire extinguisher can direct fire extinguishing material toward the location of the fire within the cabinet. For example, in at least one embodiment, the at least one fire extinguisher can include a plurality of nozzles. In at least one embodiment, each nozzle can direct fire extinguishing material toward a different location within the cabinet. In at least one embodiment, a controller can monitor the temperature sensors and open one or more of the nozzles configured to direct fire extinguishing material toward the location of the fire within the cabinet.

In at least one embodiment, the at least one fire extinguisher can include at least one nozzle configured to direct fire extinguishing material toward different locations within the cabinet. For example, the nozzle can be articulated to direct the fire extinguishing material toward the location of the fire within the cabinet. In at least one embodiment, a controller can monitor the temperature sensors and articulate, orient, or otherwise adapt the at least one nozzle to direct fire extinguishing material toward the location of the fire within the cabinet.

In at least one embodiment, the at least one fire extinguisher can direct fire extinguishing material throughout the cabinet, essentially engulfing the cabinet's interior with the fire extinguishing material, rather than directing the fire extinguishing material to a specific location within the cabinet. In at least one embodiment, the fire extinguishing material can be a dry powder, a non-conductive liquid, fire extinguishing pods, fire extinguishing gas, another fire extinguishing material, or any combination thereof.

In at least one embodiment, the at least one fire sensor can detect a direction of a fire external to the cabinet. In at least one embodiment, the at least one fire sensor can include a temperature sensor configured to detect an air temperature of the air entering the cabinet.

In at least one embodiment, the at least one fire extinguisher can include at least one nozzle configured to direct fire extinguishing material away from the cabinet. In at least one embodiment, the at least one fire extinguisher can include at least one nozzle configured to direct fire extinguishing material encircling the cabinet.

In at least one embodiment, the at least one fire extinguisher can include a plurality of nozzles. In at least one embodiment, each nozzle can direct fire extinguishing material in a different direction. In at least one embodiment, a controller can monitor the at least one fire sensor and open one or more of the nozzles configured to direct fire extinguishing material in the direction of the fire external to the cabinet.

In at least one embodiment, the at least one fire extinguisher can include a dispenser configured to eject fire extinguishing pods outward from the cabinet. In at least one embodiment, the dispenser can eject the fire extinguishing pods encircling the cabinet. In at least one embodiment, the at least one fire sensor can detect a direction of a fire external to the cabinet. In at least one embodiment, the dispenser can eject the fire extinguishing pods in the direction of the fire external to the cabinet.

In at least one embodiment, a solar shield can be mounted upon the cabinet. In at least one embodiment, the solar shield can reduce the solar induced heat within the cabinet. In at least one embodiment, the solar shield can house one or more fire sensor(s) and/or one or more fire extinguisher(s).

In at least one embodiment, the at least one fire extinguisher can include an inclined surface configured to direct fire extinguishing material toward a direction of a fire external to the cabinet. In at least one embodiment, the at least one fire extinguisher can include a stopper configured to release the fire extinguishing material upon detection of the fire external to the cabinet. In at least one embodiment, the at least one fire extinguisher can include a plunger configured to direct fire extinguishing material toward a direction of a fire external to the cabinet.

In at least one embodiment, the at least one fire extinguisher can include a tank configured to store fire extinguishing material and/or a conduit surrounding the cabinet. In at least one embodiment, the conduit can direct the fire extinguishing material toward a direction of a fire external to the cabinet upon detection of the fire external to the cabinet.

In at least one embodiment, the cabinet can include a cover configured to cover at least a portion of the at least one fire extinguisher. In at least one embodiment, the cover can uncover the portion of the at least one fire extinguisher upon detection of a fire external to the cabinet.

Other and further embodiments utilizing one or more aspects of the disclosure can be devised without departing from the spirit of Applicant's disclosure. For example, the devices, systems and methods can be implemented for numerous different types and sizes in numerous different industries. Further, the various methods and embodiments of the devices, systems and methods can be included in combination with each other to produce variations of the disclosed methods and embodiments. Discussion of singular elements can include plural elements and vice versa. The order of steps can occur in a variety of sequences unless otherwise specifically limited. The various steps described herein can be combined with other steps, interlineated with the stated steps, and/or split into multiple steps. Similarly, elements have been described functionally and can be embodied as separate components or can be combined into components having multiple functions.

The inventions have been described in the context of preferred and other embodiments and not every embodiment of the inventions has been described. Obvious modifications and alterations to the described embodiments are available to those of ordinary skill in the art having the benefits of the present disclosure. The disclosed and undisclosed embodiments are not intended to limit or restrict the scope or applicability of the inventions conceived of by the Applicant, but rather, in conformity with the patent laws, Applicant intends to fully protect all such modifications and improvements that come within the scope or range of equivalents of the following claims.

What is claimed is:

1. An electronic equipment cabinet comprising:
mounting rails for supporting electronic equipment within the cabinet;
at least one fire sensor; and
at least one fire extinguisher.

2. The cabinet of claim 1, wherein the at least one fire sensor is configured to detect fire within the cabinet and outside the cabinet.

3. The cabinet of claim 2, wherein the at least one fire sensor comprises an internal fire sensor configured to detect fire within the cabinet and an external fire sensor configured to detect fire outside the cabinet.

4. The cabinet of claim 1, wherein the at least one fire sensor comprises a plurality of temperature sensors located within the cabinet and configured to detect a fire within the cabinet and a location of the fire within the cabinet.

5. The cabinet of claim 4, wherein the at least one fire extinguisher is configured to direct fire extinguishing material toward the location of the fire within the cabinet.

6. The cabinet of claim 4, wherein the at least one fire extinguisher comprises a plurality of nozzles, with each nozzle configured to direct fire extinguishing material toward a different location within the cabinet.

7. The cabinet of claim 6, further including a controller configured to monitor the temperature sensors and open one of the nozzles configured to direct fire extinguishing material toward the location of the fire within the cabinet.

8. The cabinet of claim 4, wherein the fire extinguishing material is a dry powder.

9. The cabinet of claim 4, wherein the fire extinguishing material is a non-conductive liquid.

10. The cabinet of claim 4, wherein the at least one fire extinguisher comprises at least one nozzle configured to direct fire extinguishing material toward different locations within the cabinet.

11. The cabinet of claim 10, further including a controller configured to monitor the temperature sensors and adapt the at least one nozzle to direct fire extinguishing material toward the location of the fire within the cabinet.

12. The cabinet of claim 1, wherein the at least one fire extinguisher is configured to direct fire extinguishing material throughout the cabinet.

13. The cabinet of claim 1, wherein the at least one fire sensor comprises a temperature sensor configured to detect an air temperature of the air entering the cabinet.

14. The cabinet of claim 1, wherein the at least one fire sensor is configured to detect a direction of a fire external to the cabinet.

15. The cabinet of claim 14, wherein the at least one fire extinguisher comprises at least one nozzle configured to direct fire extinguishing material away from the cabinet.

16. The cabinet of claim 14, wherein the at least one fire extinguisher comprises at least one nozzle configured to direct fire extinguishing material encircling the cabinet.

17. The cabinet of claim 14, wherein the at least one fire extinguisher comprises a plurality of nozzles, with each nozzle configured to direct fire extinguishing material in a different direction.

18. The cabinet of claim 17, further including a controller configured to monitor the at least one fire sensor and open one of the nozzles configured to direct fire extinguishing material in the direction of the fire external to the cabinet.

19. The cabinet of claim 1, wherein the at least one fire extinguisher comprises a dispenser configured to eject fire extinguishing pods outward from the cabinet.

20. The cabinet of claim 19, wherein the dispenser is configured to eject the fire extinguishing pods encircling the cabinet.
